(19) United States
(12) Patent Application Publication
(10) Pub. No.: US 2014/0263095 A1
(43) Pub. Date: Sep. 18, 2014

(54) CHEMICAL STRAINER

(71) Applicant: Alejandro Rodriguez, The Woodlands, TX (US)

(72) Inventor: Alejandro Rodriguez, The Woodlands, TX (US)

(73) Assignee: A&O Technologies LLC, The Woodlands, TX (US)

(21) Appl. No.: 13/844,236

(22) Filed: Mar. 15, 2013

(51) Int. Cl. E21B 37/06; B01D 35/28; B01D 37/02; E21B 41/02

(52) U.S. Cl. CPC E21B 37/06; E21B 41/02; B01D 35/28; B01D 37/025
USPC 210/749; 210/499; 210/459; 210/483; 210/206

(57) ABSTRACT

A chemical strainer includes a base member that includes a base member cavity, a plurality of base member dispensing apertures disposed on a top portion of the base member, and a mating neck. A method of chemical straining includes receiving production fluids in a plurality of base member dispensing apertures of a chemical strainer. One or more chemicals disposed within the chemical strainer are dispensed. Production fluids and the dispensed chemicals are mixed. The treated production fluids are produced.

### BACKGROUND OF THE INVENTION

A producing well extracts oil and/or natural gas from one or more subsurface reservoirs of hydrocarbons. The development of a producing well includes drilling a borehole into the subsurface ground, casing the drilled borehole, and completing the cased borehole to enable production.

During the operational life of a producing well, a variety of deposits may accumulate that negatively impact production performance. Paraffin, asphaltene, salt, scale and/or corrosion may form on the surface of metals, rocks, or other materials and accumulate on wellbore tubulars, downhole equipment, and formation. Paraffin, asphaltene, salt, scale and corrosion may be caused by one or more of precipitation, bacteria, changes in temperature within the wellbore, changes in pressure within the wellbore, and the introduction of foreign phases. Typical wellbore scales include calcium carbonate, calcium sulfate, barium sulfate, strontium sulfate, iron sulfide, iron oxides, iron carbonates, and various silicates, phosphates, and oxides or compounds that are insoluble in water. When paraffin, asphaltene, salt, scale, and/or corrosion accumulate within perforations of the casing, the flow of production fluids may be restricted.

### BRIEF SUMMARY OF THE INVENTION

According to one aspect of one or more embodiments of the present invention, a chemical strainer includes a base member that includes a base member cavity, a plurality of base member dispensing apertures disposed on a top portion of the base member, and a mating neck.

According to one aspect of one or more embodiments of the present invention, a method of chemical straining includes receiving production fluids in a plurality of base member dispensing apertures of a chemical strainer. One or more chemicals disposed within the chemical strainer are dispensed. Production fluids and the dispensed chemicals are mixed. The treated production fluids are produced.

Other aspects of the present invention will be apparent from the following description and claims.

### BRIEF DESCRIPTION OF THE DRAWINGS

FIG. 1 shows a cross-sectional view of a conventional cased-hole completion.

FIG. 2 shows a side view of a chemical strainer in accordance with one or more embodiments of the present invention.

FIG. 3 shows a cross-sectional view of a chemical strainer with packed layers of chemicals in accordance with one or more embodiments of the present invention.

FIG. 4 shows a cross-sectional view of a chemical strainer with standpipe in accordance with one or more embodiments of the present invention.

FIG. 5 shows a cross-sectional view of a chemical strainer with standpipe with packed layers of chemicals in accordance with one or more embodiments of the present invention.

FIG. 6 shows a cross-sectional view of a chemical strainer deployed in a cased-hole completion in accordance with one or more embodiments of the present invention.

FIG. 7 shows a threaded dispensing aperture and a spring actuated dispensing aperture in accordance with one or more embodiments of the present invention.

FIG. 8 shows a method of chemical straining in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

FIG. 1 shows a cross-sectional view of a conventional cased-hole completion 100. Casing pipe 110 is inserted into drilled borehole 120. Casing pipe 110 is typically made of steel, steel alloys, polymers/fiberglass, or other composites and has an outer diameter that allows for the placement of casing pipe 110 within an inner diameter of drilled borehole 120. Casing pipe 110 may be secured in place by cement 130 disposed in an annulus between casing pipe 110 and drilled borehole 120. Once casing pipe 110 is cemented into place, it may be difficult to remove. As such, additional casing layers, of decreasing diameter, may be placed within casing pipe 110 to protect it from deterioration. The additional casing layers may isolate a fluid path, wiring, sensors, or other downhole equipment. Alternatively, casing stops or bottom hole assemblies may be used to isolate various downhole equipment.

Production tubing 140 may be inserted into casing pipe 110. Production tubing 140 is typically made of steel, steel alloys, polymers/fiberglass, or other composites and has an inner diameter that allows for the placement of production tubing 140 within an inner diameter of casing pipe 110. Production tubing 140 is the conduit through which production fluids, including oil, natural gas, and/or water, are transported from one or more hydrocarbon containing reservoirs to surface facilities, including a wellhead (not shown) or Christmas tree (not shown). For example, a hydrocarbon containing reservoir 150, also referred to as a producing interval, may exist within the formation at a certain depth. Another hydrocarbon containing reservoir 160, or producing interval, may exist at another depth, in this instance deeper within the ground. A production packer 170 may be placed in an annulus between production tubing 140 and casing pipe 110. Production packer 170 provides a seal between an outside surface of production tubing 140 and an inside surface of casing pipe 110. Production packer 170 may be placed at a predetermined depth above a producing interval to isolate a particular reservoir of hydrocarbons from one or more other sections of wellbore 180. A connection is made between wellbore 180 and reservoir 160 by a plurality of perforations 190. Perforations 190 are holes that extend from wellbore 180 through casing pipe 110 into the formation to provide access to reservoir 160. Perforations 190, in certain embodiments, may be formed through use of a perforating gun or other explosive device. Once perforated, the pressure differential allows oil, natural gas, and/or water to flow from reservoir 160 into wellbore 180. Production tubing 140 is positioned within casing pipe 140 to carry oil, natural gas, and/or water to the surface.

In operation, oil, natural gas, and/or water from reservoir 160 enter wellbore 180 through perforations 190 and fluids descend to the bottom of wellbore 180. Natural gas accumulates in the annulus between production tubing 140 and casing pipe 110. As liquids collect in the bottom of wellbore 180, the fluid level rises and enters production tubing 140. The production fluids may initially flow naturally as they are driven by pressure provided by the reservoir. The fluids may be allowed to flow naturally until the reservoir pressure is reduced to an amount that will not buckle the vertical leg of the wellbore from accumulated hydrostatic pressure. Alternatively, the wellbore may be shut-in by closing the wellbore. Pressure within the wellbore increases until the pressure is approximately the same as the pressure in the reservoir. The wellbore is then opened for production and natural gas within the annulus between production tubing 140 and casing pipe 110 decompresses by pushing production fluids into production tubing 140 and forcing the production fluids to the surface of the well.

An artificial lift system (not shown) may be deployed downhole to increase the flow of production fluids from a producing well. Artificial lift systems may be used in producing wells when the pressure in the reservoir is insufficient to lift the production fluids to the surface. Artificial lift systems may be used in producing wells with sufficient pressure to increase the flow rate above the natural flow rate provided by the pressure of the reservoir. Artificial lift systems may include, for example, rod pumps, plunger lifts, gas lifts, jet pumps, electric submersible pumps, or progressing cavity pumps.

During the operational life of a producing well, paraffin, asphaltene, salt, scale, and corrosion may form within the wellbore 180. Paraffin, asphaltene, salt, and scale includes accumulated deposits that clog perforations, casing pipes, production tubing, coil tubing, and downhole completion equipment. Scale accumulation can clog the wellbore, prevent fluid and gas flow, and compromise the functionality of downhole completion equipment. Common scales include calcium carbonate (CaCO₃), calcium sulfate (CaSO₄), barium sulfate (BaSO₄), strontium sulfate (SrSO₄), iron sulfide (FeS), iron oxides, iron carbonates, and various silicates, phosphates, and oxides or compounds that are insoluble in water. In addition, paraffin precipitation, asphaltene precipitation, other precipitation, bacteria, hydrates, dissolved gases such as carbon dioxide (CO₂) and hydrogen sulfide (H₂S), and salts may form within the wellbore 180 and production tubing 140, compromise the functionality of downhole completion equipment, and corrode wellbore metals and tubulars. Paraffin, asphaltene, salt, and scale accumulation can restrict a producing well in as little as 24 hours.

Producing wells are treated with chemicals that prevent the accumulation of scale and corrosion. Conventional chemical treatment methods include the use of chemical batching, continuous batching, and chemical sticks. The simplest conventional chemical treatment method includes injecting chemicals directly from the surface into wellbore 180, where the chemicals settle at the bottom of wellbore 180 or mixes with the fluids in wellbore 180. Over time, the concentration of the chemicals decreases in a non-uniform manner. At the time of treatment, the chemical concentration is at its highest and may be excessive. After a period of time, the chemical concentration is substantially reduced and may be inadequate. Because the concentration of chemicals cannot be controlled, the application of chemicals to the fluid and gas flow is non-uniform and largely ineffective long term.

Another conventional chemical treatment method includes the use of a chemical dispenser suspended downhole and submersed within the fluid level. The chemical dispenser is fixed in place as part of the production tubing 140. The dispenser includes a number small orifices formed in the wall of the dispenser to provide communication between the dispenser and the fluids in the wellbore. When the dispenser is submersed within the fluid level for a period of time, the orifices become clogged with solid materials that inhibit the operation of the dispenser. A limitation of this approach is that a substantial portion of the production tubing must be removed to dislodge the solid materials that clog the orifices and replenish the chemicals at great expense in a time-consuming process that renders the well non-producing.

A common limitation of conventional chemical treatment methods is the lack of control over the dispensation of chemicals in the production fluids. The chemicals are in complete and constant communication with the production fluids. As a consequence, the chemicals are rapidly depleted in an uncontrollable manner. In addition, the concentration of chemicals cannot be controlled. When the chemicals are initially deployed, the chemical concentration in the production fluids is high. Over time, the chemical concentration is substantially reduced. Thus, the concentration of chemicals is non-uniform over time. Furthermore, because the chemicals are in constant communication with the production fluids, it is not possible to sequence different chemical treatments for different scale and/or corrosion problems.

In one or more embodiments of the present invention, a chemical strainer provides controlled dispensation of one or more chemicals in the production fluids at a desired concentration that may be substantially uniform over time. In addition, a chemical strainer with packed chemicals may provide sequenced dispensation of one or more different chemical treatments for different accumulation, scale, and/or corrosion problems over time.

FIG. 2 shows a side view of a chemical strainer 200 in accordance with one or more embodiments of the present invention. In one or more embodiments of the present invention, chemical strainer 200 includes a base member 210 that may be cylindrical in shape. In one or more embodiments of the present invention, a cavity (not shown) disposed within base member 210 may span an axial length 220 of base member 210. The base member 210 may be composed of steel, steel alloys, polymers/fiberglass, or other composites. In one or more embodiments of the present invention, an axial length 220 of base member 210 may be selected to accommodate the treatment needs of a particular producing well, tank, vessel, or pipeline and fluid and gas flow rate. In one or more embodiments of the present invention, a diameter 230 of base member 210 may be selected to accommodate the treatment needs of a particular producing well, tank, vessel, or pipeline and fluid and gas flow rate. Diameter 230 of base member 210 is typically smaller than a diameter of production tubing (not shown) in which it is deployed. In one or more embodiments of the present invention, axial length 220 and diameter 230 of base member 210 may be selected to accommodate the treatment needs of a particular producing well, tank, vessel, or pipeline and fluid and gas flow rate.

In one or more embodiments of the present invention, a dispensing aperture 260 may be disposed on a top portion of base member 210. In certain embodiments, dispensing aperture 260 may be disposed on a middle portion of base member 210. In other embodiments, dispensing aperture 260 may be disposed on a bottom portion of base member 210. Dispensing aperture 260 allows fluid communication between production fluids and chemicals disposed within the cavity of base member 210. Dispensing aperture 260 may be a substantially circular hole in base member 210. Dispensing aperture 260 may be a threaded hole in base member 210. Dispensing aperture 260 may be a mechanically adjustable hole in base member 210 with an aperture that can be mechanically adjusted. Dispensing aperture 260 may be a removable and replaceable port hole that allows for the use of port holes of different sizes on the same chemical strainer 200. For example, in one embodiment a removable port hole may threadably engage a hole in base member 210, thereby allowing the size of dispensing aperture 260 to be adjusted based on the requirements of the treatment operation. Dispensing aperture 260 may be a spring actuated aperture that dispenses chemicals when a plunger (not shown) hits the top of chemical strainer 200 during plunging operations. Dispensing aperture 260 may be one or more apertures in the threads adjustably exposed by a threaded cap (not shown) disposed on a top portion of chemical strainer 200. One of ordinary skill in the art will recognize that the shape, type, and location of dispensing aperture 260 may vary in accordance with one or more embodiments of the present invention.

In one or more embodiments of the present invention, dispensing aperture 260 may have a diameter of approximately ⅜ inch. In one or more embodiments of the present invention, dispensing aperture 260 may have a diameter in a range between approximately 1/16 inch to approximately ½ inch. In one or more embodiments of the present invention, dispensing aperture 260 may have a diameter greater than approximately ½ inch.

In one or more embodiments of the present invention, two dispensing apertures 260 may be disposed on a top portion of base member 210. In one or more embodiments of the present invention, three dispensing apertures 260 may be disposed on a top portion of base member 210. In one or more embodiments of the present invention, four dispensing apertures 260 may be disposed on a top portion of base member 210. In one or more embodiments of the present invention, five dispensing apertures 260 may be disposed on a top portion of base member 210. In embodiments that include two or more dispensing apertures 260, the dispensing apertures 260 may be spaced evenly about a top portion of base member 210. In embodiments that include two or more dispensing apertures 260, the dispensing apertures 260 may be grouped together about a top portion of base member 210. In certain embodiments, dispensing apertures 260 may be disposed on a middle portion of base member 210. In other embodiments, dispensing apertures 260 may be disposed on a bottom portion of base member 210.

Chemical strainer 200 includes a mating neck 240 that provides a connection to downhole completion equipment disposed above chemical strainer 200 within the production tubing string (not shown). In one or more embodiments of the present invention, mating neck 240 may include a wireline connection (not shown) suitable for deploying chemical strainer 200 downhole by wireline. In one or more embodiments of the present invention, mating neck 240 may be configured to engage other deployment equipment, such as pipe or coiled tubing (not shown). In one or more embodiments of the present invention, mating neck 240 may provide a connection to an artificial lift system (not shown) disposed above chemical strainer 200 within the production tubing string (not shown). In one or more embodiments of the present invention, mating neck 240 may be configured to engage a casing stop (not shown) or feature disposed within a well, tank, vessel, or pipeline. In one or more embodiments of the present invention, mating neck 240 may be a plunger neck. In one or more embodiments of the present invention, mating neck 240 may be an inner diameter plunger neck. In one or more embodiments of the present invention, mating neck 240 may be an outer diameter plunger neck. In one or more embodiments of the present invention, mating neck 240 may be a screw on neck. In one or more embodiments of the present invention, mating neck 240 may be a snap on neck. In one or more embodiments of the present invention, mating neck 240 may be a ball neck. In one or more embodiments of the present invention, mating neck 240 may be a socket neck. One of ordinary skill in the art will recognize that other mating necks 240 may be used in accordance with one or more embodiments of the present invention.

Chemical strainer 200 may include a mating dock 250 that provides a connection to a downhole anchor disposed below chemical strainer 200 within the production tubing string. In one or more embodiments of the present invention, mating dock 250 may provide a connection to a downhole anchor, such as a mud anchor (not shown), disposed on the bottom of the wellbore. In one or more embodiments of the present invention, mating dock 250 may provide a connection to collar stop or casing/tubing stop. In one or more embodiments of the present invention, mating dock 250 may provide a connection to an anchor disposed on a tank, vessel, or pipeline. One of ordinary skill in the art will recognize that other mating docks may be used in accordance with one or more embodiments of the present invention.

In one or more embodiments of the present invention, chemicals (not shown) may be disposed within the cavity (not shown) of base member 210. In one or more embodiments of the present invention, the chemicals (not shown) may be disposed in packed layers within the cavity (not shown). In one or more embodiments of the present invention, the chemicals (not shown) may be disposed in a chemical cartridge (not shown) disposed within the cavity (not shown) of base member 210. In one or more embodiments of the present invention, the chemicals (not shown) may be disposed in packed layers in a chemical cartridge (not shown) disposed within the cavity (not shown) of base member 210.

In one or more embodiments of the present invention, the chemicals may include any chemicals or chemical compounds suitable for the treatment of production fluids to prevent or inhibit paraffin, asphaltene, salt, bacteria, H₂S, CO₂, scale, and/or corrosion. In one or more embodiments of the present invention, the chemicals may include any combination of chemicals or chemical compounds suitable for the treatment of production fluids to prevent or inhibit paraffin, asphaltene, salt, bacteria, H₂S, CO₂, scale, and/or corrosion. In one or more embodiments of the present invention, the chemicals may include any combination of chemicals or chemical compounds arranged in packed layers suitable for the treatment of production fluids to prevent or inhibit paraffin, asphaltene, salt, bacteria, H₂S, CO₂, scale and/or corrosion. In one or more embodiments of the present invention, the chemicals may include any chemicals or chemical compounds suitable for the treatment of a fluid flow or gas flow. In one or more embodiments of the present invention, the chemicals may be dry, liquid, gel, or polymers with absorbed/adsorbed chemicals, such as bed filters. In one or more embodiments of the present invention, the chemicals may be slow release chemicals. In one or more embodiments of the present invention, the chemicals may include a mixture of dry and/or liquid chemicals or chemical compounds suspended in an aqueous solution.

FIG. 3 shows a cross-sectional view of a chemical strainer 200 with packed layers of chemicals in accordance with one or more embodiments of the present invention. In one or more embodiments of the present invention, chemicals may be disposed in a single packed layer 310 disposed within the cavity of base member 210. In one or more embodiments of the present invention, chemicals may be disposed in a plurality of packed layers 310 disposed within the cavity of base member 210. In one or more embodiments of the present invention, chemicals may be disposed in a single packed layer 310 in a chemical cartridge (not shown) disposed within the cavity of base member 210. In one or more embodiments of the present invention, chemicals may be disposed in a plurality of packed layers 310 in a chemical cartridge (not shown) disposed within the cavity of base member 210. In one or more embodiments of the present invention, the number of packed layers of chemicals 310 may vary depending on the treatment needs of a particular producing well, tank, vessel, or pipeline and fluid and gas flow rate.

In one or more embodiments of the present invention, a plurality of packed layers 310 are isolated from one another by a plurality of dissolvable isolation layers 320. In one or more embodiments of the present invention, dissolvable isolation layers 320 may be composed of paraffin, wax, clay, paper, light polymer, or combinations thereof. In one or more embodiments of the present invention, dissolvable isolation layers 320 may be composed of any suitable composition capable of isolating one packed layer from another and dissolvable by interaction with the production fluids. In one or more embodiments of the present invention, the composition of dissolvable isolation layers 320 may vary from layer to layer. In one or more embodiments of the present invention, the composition of each of dissolvable isolation layers 320 may vary depending on the composition of the packed layers disposed on either side of the isolation layer. One of ordinary skill in the art will recognize that the composition of dissolvable isolation layers 320 may vary in accordance with one or more embodiments of the present invention.

As production fluids enter dispensing apertures 260, a first layer of packed chemicals 310, disposed nearest dispensing apertures 260, are exposed and production fluids communicate with the first layer of packed chemicals 310. Over time, the first layer of packed chemicals 310 is depleted by interaction with production fluids. Once the first layer of packed chemicals 310 is dissolved, a first dissolvable isolation layer 320 is exposed and dissolved by the production fluids. Then production fluids entering dispensing apertures 260 fluidly communicate with a second layer of packed chemicals 310 disposed below the position where the first layer of packed chemicals 310 resided prior to depletion. Over time, the second layer of packed chemicals 310 is depleted by interaction with production fluids. Once the second layer of packed chemicals 310 is dissolved, a second dissolvable isolation layer 320 is exposed and quickly dissolved by the production fluids. In one or more embodiments of the present invention, this process may continue for a plurality of layers of packed chemicals 310 and a plurality of thin dissolvable layers 320 disposed within a cavity of base member 210.

In one or more embodiments of the present invention, the number of layers of packed chemicals 310 may be in a range between 1 and 10. In one or more embodiments of the present invention, the number of dissolvable isolation layers 320 may be in a range between 1 and 10. In one or more embodiments of the present invention, the number of layers of packed chemicals 310 may be in a range between 11 and 20. In one or more embodiments of the present invention, the number of dissolvable isolation layers 320 may be in a range between 11 and 20. In one or more embodiments of the present invention, the number of layers of packed chemicals 310 may be greater than 20. In one or more embodiments of the present invention, the number of dissolvable isolation layers 320 may be greater than 20. One of ordinary skill in the art will recognize that the number of layers of packed chemicals 310 and the number of layers of dissolvable isolation layers 320 may be varied in accordance with one or more embodiments of the present invention.

In one or more embodiments of the present invention, each packed layer of chemicals 310 may include a different type of treatment chemical or chemicals suitable for treating a specific problem or problems. For example, a first packed layer of chemicals 310 may include a chemical or chemicals suitable for treating paraffin accumulation, a second packed layer of chemicals 310 may include a chemical or chemicals suitable for treating scale accumulation, and a third packed layer of chemicals 310 may include a chemical or chemicals suitable for treating both paraffin and scale accumulation. In one or more embodiments of the present invention, chemical strainer 200 may include a plurality of packed layers of chemicals 310, where each layer may include one or more treatment chemicals suitable for treating a specific problem or problems. In one or more embodiments of the present invention, chemical strainer 200 may include a plurality of packed layers of chemicals 310, where the chemical or chemicals disposed in a given layer are selected so that a specific sequence of treatments are applied in a sequential manner over time. In certain embodiments, one or more packed layers of chemicals 310 may include water conditioning chemicals, biocide chemicals, demulsifiers, or corrosion inhibitors. One of ordinary skill in the art will recognize that the composition of one or more packed layers of chemicals 310 may include chemicals to treat one or more production fluids including oil, natural gas, and water, biologicals, or protective agents for downhole equipment.

In one or more embodiments of the present invention, a chemical concentration of each packed layer of chemicals 310 may vary from layer to layer. Accordingly, the applied concentration of chemicals to the production fluids may be controlled. For example, the issues of scale and/or corrosion may increase during the operational life of a producing well, tank, vessel, or pipeline. A first layer of packed chemicals 310 may have a concentration suitable for initial use and subsequent layers of packed chemicals may have a higher concentration of chemicals suitable for later use.

In one or more embodiments of the present invention, a thickness of each packed layer of chemicals 310 may vary from layer to layer. Accordingly, specific treatments may be applied over different time intervals. For example, a first layer of packed chemicals 310 may have a thickness suitable for treating a specific problem or problems for an appropriate period of time and subsequent layers of packed chemicals 310 may have a thickness suitable for treating a specific problem or problems for a different period of time.

In one or more embodiments of the present invention, one or more of a diameter of base member 210, a number of dispensing apertures 260, a placement of dispensing apertures 260, a number of packed layers of chemicals 310, a type of chemical or chemicals disposed in each layer of packed layers of chemicals 310, a concentration of chemicals disposed in each layer of packed layers of chemicals 310, and a thickness of each layer of packed layers of chemicals 310 may vary depending on the treatment needs of a particular producing well, tank, vessel, or pipeline and fluid and gas flow rate. In one or more embodiments of the present invention, one or more of a diameter of base member 210, a number of dispensing apertures 260, a placement of dispensing apertures 260, a number of packed layers of chemicals 310, a type of chemical or chemicals disposed in each layer of packed layers of chemicals 310, a concentration of chemicals disposed in each layer of packed layers of chemicals 310, and a thickness of each layer of packed layers of chemicals 310 may vary to provide controlled dispensation of one or more chemicals in one or more concentrations for varying lengths of time.

In operation, production fluids enter chemical strainer 200 via one or more dispensing apertures 260 and fluidly communicate with one or more packed layers of chemicals 310 disposed within base member 210. Treated production fluids then exit one or more dispensing apertures 260.

FIG. 4A shows a cross-sectional view of a chemical strainer 200 with a standpipe 410 in accordance with one or more embodiments of the present invention. Chemical strainer 200 with standpipe 410, collectively referred to as chemical strainer 400, is similar to chemical strainer 200 of FIG. 2, but includes a standpipe 410 in which the treatment chemicals are disposed. The standpipe 410 may be disposed within the cavity of base member 210. Standpipe 410 may by a cylindrical member composed of steel, steel alloys, polymers/fiberglass, or other composites. Standpipe 410 may traverse an axial length of base member 210. Standpipe 410 may be fixed in place or removable. A tank 430 may be formed by an annulus between standpipe 410 and base member 210.

FIG. 4B shows a cross-sectional view of a standpipe 410 in accordance with one or more embodiments of the present invention. Standpipe 410 is a substantially closed receptacle that includes a standpipe dispensing aperture 420 disposed on a top portion of standpipe 410. Standpipe dispensing aperture 420 allows fluid communication between production fluids and chemicals disposed within a cavity of standpipe 410. Standpipe dispensing aperture 420 may be a substantially circular hole in standpipe 410. Standpipe dispensing aperture 420 may be a threaded hole in standpipe 410. Standpipe dispensing aperture 420 may be a mechanically adjustable hole in standpipe 410 with an aperture that can be mechanically adjusted. Standpipe dispensing aperture 420 may be a removable and replaceable port hole that allows for the use of port holes of different sizes on the same chemical strainer with standpipe 400. For example, in one embodiment a removable port hole may threadably engage a hole in standpipe 410, thereby allowing the size of standpipe dispensing aperture 420 to be adjusted based on the requirements of the treatment operation. Standpipe dispensing aperture 420 may be a spring actuated aperture that dispenses chemicals when a plunger (not shown) hits the top of chemical strainer 200 with standpipe 410 during plunging operations. Standpipe dispensing aperture 420 may be one or more apertures in the threads adjustably exposed by a threaded cap (not shown) on a top portion of chemical strainer 200 with standpipe 410. One of ordinary skill in the art will recognize that the shape and type of standpipe dispensing aperture 420 may vary in accordance with one or more embodiments of the present invention.

In one or more embodiments of the present invention, standpipe dispensing aperture 420 may have a diameter of approximately ⅜ inch. In one or more embodiments of the present invention, standpipe dispensing aperture 420 may have a diameter in a range between approximately 1/16 inch to approximately ½ inch. In one or more embodiments of the present invention, standpipe dispensing aperture 420 may have a diameter greater than approximately ½ inch.

In one or more embodiments of the present invention, two standpipe dispensing apertures 420 may be disposed on a top portion of standpipe 410. In one or more embodiments of the present invention, three standpipe dispensing apertures 420 may be disposed on a top portion of standpipe 410. In one or more embodiments of the present invention, four standpipe dispensing apertures 420 may be disposed on a top portion of standpipe 410. In one or more embodiments of the present invention, five standpipe dispensing apertures 420 may be disposed on a top portion of standpipe 410. In embodiments that include two or more standpipe dispensing apertures 420, the standpipe dispensing apertures 420 may be spaced evenly about a top portion of standpipe 410. In embodiments that include two or more standpipe dispensing apertures 420, the standpipe dispensing apertures 420 may be grouped together about a top portion of standpipe 410. One of ordinary skill in the art will recognize that the shape, number, and location of standpipe dispensing ports 420 may vary in accordance with one or more embodiments of the present invention.

In one or more embodiments of the present invention, an axial length and diameter of standpipe 410 may be selected to accommodate the treatment needs of a particular producing well, tank, vessel, or pipeline and fluid and gas flow rate. In one or more embodiments of the present invention, an axial length and diameter of standpipe 290 may be selected to achieve a desired diffusion of chemicals.

FIG. 5 shows a cross-sectional view of a standpipe 410 with packed layers of chemicals 310 in accordance with one or more embodiments of the present invention. In one or more embodiments of the present invention, chemicals may be disposed in a single packed layer 310 disposed within the cavity of standpipe 410. In one or more embodiments of the present invention, chemicals may be disposed in a plurality of packed layers 310 disposed within the cavity of standpipe 410. In one or more embodiments of the present invention, chemicals may be disposed in a single packed layer 310 in a chemical cartridge (not shown) disposed within the cavity of standpipe 410. In one or more embodiments of the present invention, chemicals may be disposed in a plurality of packed layers 310 in a chemical cartridge (not shown) disposed within the cavity of standpipe 410. In one or more embodiments of the present invention, the number of packed layers of chemicals 310 may vary depending on the treatment needs of a particular producing well, tank, vessel, or pipeline and fluid and gas flow rate.

In one or more embodiments of the present invention, one or more of a diameter of standpipe 410, a number of standpipe dispensing apertures 420, a placement of standpipe dispensing apertures 410, a number of packed layers of chemicals 310, a type of chemical or chemicals disposed in each layer of packed layers of chemicals 310, a concentration of chemicals disposed in each layer of packed layers of chemicals 310, and a thickness of each layer of packed layers of chemicals 310 may vary depending on the treatment needs of a particular producing well, tank, vessel, or pipeline and fluid and gas flow rate. In one or more embodiments of the present invention, one or more of a diameter of standpipe 410, a number of standpipe dispensing apertures 420, a placement of standpipe dispensing apertures 420, a number of packed layers of chemicals 310, a type of chemical or chemicals disposed in each layer of packed layers of chemicals 310, a concentration of chemicals disposed in each layer of packed layers of chemicals 310, and a thickness of each layer of packed layers of chemicals 310 may vary to provide controlled dispensation of one or more chemicals in one or more concentrations for varying lengths of time.

In operation, production fluids enter chemical strainer (400 of FIG. 4) via one or more dispensing apertures (260 of FIG. 4) and enter one or more standpipe dispensing apertures (420 of FIGS. 4B and 5). The production fluids fluidly communicate with one or more packed layers of chemicals disposed within standpipe (410 of FIG. 5). Production fluids and chemicals may mix in tank (430 of FIG. 4A) prior to exiting one or more dispensing apertures 260.

FIG. 6 shows a cross-sectional view of a chemical strainer 200 deployed in a cased-hole completion in accordance with one or more embodiments of the present invention. In one or more embodiments of the present invention, chemical strainer 200 may be deployed in production tubing 140 by wireline (not shown). In one or more embodiments of the present invention, chemical strainer may be deployed through a string of production tubing 140. In one or more embodiments of the present invention, chemical strainer 200 may be deployed downhole below an existing artificial lift system (not shown). Chemical strainer 200 may be deployed in a selected producing interval 160. In one or more embodiments of the present invention, chemical strainer 200 may be deployed in multiple production zones of a producing well with multiple producing intervals. In one or more embodiments of the present invention, chemical strainer 200 may be secured to production tubing 140 by a mud anchor (not shown). In one or more embodiments of the present invention, chemical strainer 200 may be secured to the bottom of the wellbore (not shown). In one or more embodiments of the present invention, chemical strainer 200 may be an extension to a gas anchor (not shown), tail pipe (not shown), sub to a packer (not shown), tubing/casing stop, or any other type of wireline/coil tubing retrievable object.

In one or more embodiments of the present invention, production fluids, including oil, natural gas, and/or water/brine may enter production tubing 140 via perforated sub 610. In one or more embodiments of the present invention, perforated sub 610 of production tubing 140 may be located above the plurality of dispensing ports 260 of base member 210. In certain wells, rather than perforated sub 610, alternative methods for providing fluid communication between the wellbore 180 and production tubing 140 may be used such as, for example, sliding sleeves (not shown). The production fluids enter chemical strainer 200 via one or more dispensing apertures 260. The one or more dispensing apertures 260 provide fluid communication between one or more chemicals 310 disposed within base member 210 and production fluids to form a saturated solution of treatment chemicals and production fluids. When chemical strainer 200 is flushed, by natural flow or artificial lift, the turbulence of the flow within production tubing 140 causes a metered volume of saturated solution to be withdrawn from base member 210 and mixed with the production fluids. The treated production fluids may then travel to the surface of wellbore 180 through production tubing 140.

In embodiments where chemical strainer 200 includes standpipe (410 of FIGS. 4 and 5), production fluids, including oil, natural gas, and/or water/brine may enter production tubing 140 via perforated sub 610. The production fluids enter chemical strainer 200 via one or more dispensing apertures 260. Once in chemical strainer 200, production fluids enter standpipe (410 of FIGS. 4 and 5) via one or more standpipe dispensing apertures (420 of FIGS. 4B and 5). The one or more standpipe dispensing apertures (420 of FIGS. 4B and 5) provide fluid communication between one or more chemicals 310 disposed within standpipe (410 of FIGS. 4 and 5) and production fluids to form a saturated solution of treatment chemicals and production fluids. When chemical strainer 200 with standpipe (410 of FIGS. 4 and 5) is flushed, by natural flow or artificial lift, the turbulence of the flow within production tubing 140 causes a metered volume of saturated solution to be withdrawn from standpipe (410 of FIGS. 4 and 5) and mixed with the production fluids. The chemicals and production fluids may mix in tank (430 of FIG. 4) and production tubing 140. The treated production fluids may then travel to the surface of wellbore 180 through production tubing 140.

In one or more embodiments of the present invention, chemical strainer 200 may be removed from production tubing 140 by wireline. In one or more embodiments of the present invention, a chemical strainer may be removed by wireline from a producing well or pipeline to replenish treatment chemicals. One of ordinary skill in the art will recognize that chemical strainer 200 may be deployed in an open-hole completion in accordance with one or more embodiments of the present invention. Additionally, one of ordinary skill in the art will recognize that chemical strainer 200 may be deployed in a pipeline, tank, container, vessel, or other fluid and gas flow conduit in accordance with one or more embodiments of the present invention.

FIG. 7 shows a threaded dispensing aperture and a spring actuated dispensing aperture in accordance with one or more embodiments of the present invention. In FIG. 7A, a base member 710 may include a plurality of dispensing apertures 720. Dispensing apertures 720 may be disposed in a threaded portion of base member 710 disposed on a top portion of base member 710. In certain embodiments, dispensing apertures 720 may be disposed on a middle portion of base member 710. In other embodiments, dispensing apertures 720 may be disposed on a bottom portion of base member 710. A cap 730 may threadably engage the threaded portion of base member 710. Cap 730 may be adjusted to expose a desired number of dispensing apertures 730. In one or more embodiments of the present invention, base member 710 may be base member 210 and dispensing apertures 720 may be dispensing apertures 260. In one or more embodiments of the present invention, base member 710 may be standpipe 410 and dispensing apertures 720 may be standpipe dispensing apertures 420. In operation, cap 730 may be adjusted to expose a desired number of dispensing apertures 730 suitable for a particular application. One of ordinary skill in the art will recognize that base member 710 may be deployed in a pipeline, tank, container, vessel, or other fluid and gas flow conduit.

In FIG. 7B, a base member 740 may be disposed in a well (not shown). A stand pipe 410 may be disposed within base member 740. A spring 770 may be disposed above, within, or partially within standpipe 410 and/or base member 740. A moveable sleeve 750, including one or more dispensing apertures 760 may be disposed above or otherwise connected to spring 770. Spring 770 may be biased to keep moveable sleeve 750 in a closed condition, e.g., located above stand pipe 410 and/or or base member 740. During actuation, a plunger (now shown) may be disposed in a well (not shown). When the plunger moves axially down the well and into contact with moveable sleeve 750, moveable sleeve 750 may axially translate downward into stand pipe 410 and/or or base member 740. As the moveable sleeve 750 moves into stand pipe 410 and/or base member 740, the dispensing apertures 760 may open or otherwise allow fluid communication between the well and stand pipe 410 and/or base member 740. Fluid may then flow into stand pipe 410 and/or base member 740, thereby allowing fluid from the well to mix with one or more chemicals in the standpipe 410 and/or base member 740. In such an embodiment, fluids may enter stand pipe 410 and flow into base member 740, where the fluids mix with chemicals (not independently shown), which are disposed therein. The fluids may then move into the well as moveable sleeve 750 translates axially upward out of stand pipe 410 and/or base member 740.

Those of ordinary skill in the art will appreciate that in certain embodiments, the fluids may be dispensed above standpipe 410 and/or base member 740. In other embodiments, spring 770 may be disposed substantially around moveable sleeve 750, such that axially translation of moveable sleeve 750 causes moveable sleeve 750 to translate axially downward into stand pipe 410 and/or base member 740. Those of ordinary skill in the art will further appreciate that in certain embodiments, stand pipe 410 is not required, and moveable sleeve 750 may translate into base member 740.

In other embodiments, a base member 740 may include a plurality of spring actuated dispensing apertures 760. Spring actuated dispensing apertures 760 may be disposed in a movable sleeve 750 disposed on top portion of base member 740. In certain embodiments, dispensing apertures 760 may be disposed in a moveable sleeve 750 disposed on a middle portion of base member 740. In other embodiments, dispensing apertures 760 may be disposed in a moveable sleeve 750 disposed on a bottom portion of base member 740. A spring 770 may engage moveable sleeve 750 to expose spring actuated dispensing apertures 760. In one or more embodiments of the present invention, base member 740 may be base member 210 and dispensing apertures 760 may be dispensing apertures 260. In one or more embodiments of the present invention, base member 740 may be standpipe 410 and dispensing apertures 760 may be standpipe dispensing apertures 420. During plunging operations, a plunger (not shown) may depress spring 770 that engages moveable sleeve 750 to expose one or more spring actuated dispensing apertures 760. In operation, moveable sleeve 750 and spring 770 may be adjusted to expose a desired number of dispensing apertures 760 suitable for a particular application. One of ordinary skill in the art will recognize that base member 740 may be deployed in a pipeline, tank, container, vessel, or other fluid and gas flow conduit.

FIG. 8 shows a method of chemical straining in accordance with one or more embodiments of the present invention. In one or more embodiments of the present invention, a chemical strainer may be deployed in a producing well, tank, vessel, pipeline, container, or fluid or gas flow conduit to chemically treat production fluids by a chemical straining process.

In step 810, production fluids may be received by a chemical strainer. The production fluids may be received by a plurality of base member dispensing apertures disposed on a top portion of a base member into a base member cavity. In one or more embodiments of the present invention, the base member cavity substantially spans a diameter and axial length of the base member. In embodiments that include a standpipe, production fluids may be received by a plurality of standpipe dispensing apertures disposed on a top portion of the standpipe into a standpipe cavity. In one or more embodiments of the present invention, the standpipe cavity substantially spans a diameter and axial length of the base member. The standpipe may be disposed within the base member cavity.

In step 820, one or more chemicals may be dispensed from the chemical strainer. In one or more embodiments of the present invention, one or more chemicals may be dispensed from a packed layer of one or more chemicals. In one or more embodiments of the present invention, one or more chemicals may be dispensed from a plurality of packed layers, where each packed layer comprises one or more treatment chemicals. In one or more embodiments of the present invention, the plurality of packed layers may be disposed within the base member cavity. In one or more embodiments of the present invention, the plurality of packed layers may be disposed within the standpipe cavity. In one or more embodiments of the present invention, the plurality of packed layers may be disposed within a chemical cartridge. The chemical cartridge may be disposed within the base member cavity or the standpipe cavity. In one or more embodiments of the present invention, the plurality of packed layers may be isolated from one another by one or more dissolvable isolation layers. In one or more embodiments of the present invention, a type of one or more treatment chemicals disposed within each packed layer is predetermined. In one or more embodiments of the present invention, a concentration of one or more treatment chemicals disposed within each packed layer is predetermined. In one or more embodiments of the present invention, a volume of one or more treatment chemicals disposed within each packed layer is predetermined.

In step 830, the production fluid and the dispensed chemicals are mixed. In one or more embodiments of the present invention, the production fluids and the dispensed chemicals may be mixed in the annulus between the chemical strainer and the production tubing in between flushing actions. In one or more embodiments of the present invention, the production fluids and the dispensed chemicals may be mixed in an exposed portion of the base member cavity. In one or more embodiments of the present invention, the production fluids and the dispensed chemicals may be mixed in an annulus between the standpipe and the base member in between flushing actions. In one or more embodiments of the present invention, the production fluids and the dispensed chemicals may be mixed in an exposed portion of the standpipe cavity. In one or more embodiments of the present invention, the mixing action may take place in a combination of any exposed portion of any cavity and any annulus where production fluids and treatment chemicals communicate. For example, when the production tubing is flushed, by natural flow or by artificial lift, the turbulence of the flow within the production tubing may cause a metered amount of saturated solution to be dispensed from the chemical strainer and mixed with the production fluids. In step 840, the treated production fluids are produced.

Advantages of one or more embodiments of the present invention may include one or more of the following:

In one or more embodiments of the present invention, a chemical strainer provides controlled dispensation of one or more treatment chemicals to a production fluid and gas flow.

In one or more embodiments of the present invention, a chemical strainer provides controlled dispensation of one or more treatment chemicals in a predetermined concentration.

In one or more embodiments of the present invention, a chemical strainer provides controlled dispensation of one or more treatment chemicals in a substantially uniform concentration.

In one or more embodiments of the present invention, a chemical strainer provides controlled dispensation of one or more treatment chemicals at different times.

In one or more embodiments of the present invention, a chemical strainer provides controlled dispensation of a sequence of one or more treatment chemicals over time.

In one or more embodiments of the present invention, a chemical strainer provides controlled dispensation of a sequence of one or more treatment chemicals, where each set of treatment chemicals in the sequence may vary in the type of treatment chemicals, the concentration of treatment chemicals, and the treatment period.

In one or more embodiments of the present invention, a chemical strainer efficiently removes paraffin, asphaltene, salt, H2S, CO2, bacteria, emulsion, scale and/or corrosion and changes rock wettability.

In one or more embodiments of the present invention, a chemical strainer may be deployed by wireline or a string of production tubing, production casing, or coil tubing.

In one or more embodiments of the present invention, a chemical strainer may be deployed in a selected producing interval of a producing well with multiple producing intervals.

In one or more embodiments of the present invention, a chemical strainer may be deployed in multiple production zones of a producing well with multiple producing intervals.

In one or more embodiments of the present invention, a chemical strainer may be removed by wireline from a producing well or pipeline.

In one or more embodiments of the present invention, a chemical strainer may be removed by wireline from a producing well or pipeline to replenish treatment chemicals.

In one or more embodiments of the present invention, a chemical strainer may be removed from a producing well without removing production tubing.

In one or more embodiments of the present invention, a chemical strainer may be installed with existing artificial lift systems.

In one or more embodiments of the present invention, a chemical strainer may be used with cased-hole completions.

In one or more embodiments of the present invention, a chemical strainer may be used with open-hole completions.

In one or more embodiments of the present invention, a chemical strainer may be used inside surface flowlines.

In one or more embodiments of the present invention, a chemical strainer may be used to scrub and/or sweeten gas coming into tubing or surface pipelines.

In one or more embodiments of the present invention, a chemical strainer may be used with pipelines, tanks, vessels, containers, or other fluid or gas flow conduits.

In one or more embodiments of the present invention, a chemical strainer may have an axial length and diameter configured for treatment of a particular producing well or pipeline.

In one or more embodiments of the present invention, a chemical strainer may include a standpipe that may have an axial length and diameter configured for treatment of a particular producing well or pipeline.

In one or more embodiments of the present invention, a chemical strainer stabilizes productivity of a producing well or pipeline.

In one or more embodiments of the present invention, a chemical strainer increases productivity of a producing well or pipeline.

In one or more embodiments of the present invention, a chemical strainer extends the operational life of a producing well or pipeline.

In one or more embodiments of the present invention, a chemical strainer creates a lower drawdown and assists lifting liquids by reducing/minimizing chokes and plugs.

In one or more embodiments of the present invention, a chemical strainer may be more efficient compared to conventional chemical treatment methods.

In one or more embodiments of the present invention, a chemical strainer may have a longer operational life compared to conventional chemical treatment methods.

In one or more embodiments of the present invention, a chemical strainer may reduce fabrication costs compared to conventional chemical treatment methods.

In one or more embodiments of the present invention, a chemical strainer may be easier to deploy compared to conventional chemical treatment methods.

In one or more embodiments of the present invention, a chemical strainer may be more economical compared to conventional chemical treatment methods.

In one or more embodiments of the present invention, a chemical strainer may be serviced more easily compared to conventional chemical treatment methods.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A chemical strainer comprising:
a base member comprising a base member cavity;
a plurality of base member dispensing apertures disposed on a top portion of the base member; and
a mating neck.

2. The chemical strainer of claim 1, further comprising:
a standpipe disposed within the base member cavity, the standpipe comprising a standpipe cavity.

3. The chemical strainer of claim 2, further comprising:
a plurality of standpipe dispensing apertures disposed on top portion of the standpipe.

4. The chemical strainer of claim 1, further comprising:
a mating dock.

5. The chemical strainer of claim 1, further comprising:
a packed layer of one or more chemicals.

6. The chemical strainer of claim 1, further comprising:
a plurality of packed layers, each packed layer comprising one or more chemicals.

7. The chemical strainer of claim 1, wherein the plurality of base member dispensing apertures are spring actuated apertures.

8. The chemical strainer of claim 1, wherein the plurality of base member dispensing apertures are threaded apertures.

9. The chemical strainer of claim 3, wherein the plurality of standpipe dispensing apertures are spring actuated apertures.

10. The chemical strainer of claim 3, wherein the plurality of standpipe dispensing apertures are threaded apertures.

11. The chemical strainer of claim 6, wherein the plurality of packed layers are disposed within the base member cavity.

12. The chemical strainer of claim 6, wherein the plurality of packed layers are disposed within the standpipe cavity.

13. The chemical strainer of claim 6, wherein the plurality of packed layers are disposed in a chemical cartridge.

14. The chemical strainer of claim 13, wherein the chemical cartridge is disposed within the base member cavity.

15. The chemical strainer of claim 13, wherein the chemical cartridge is disposed within the standpipe cavity.

16. The chemical strainer of claim 6, wherein a type of one or more chemicals disposed within each packed layer is predetermined.

17. The chemical strainer of claim 6, wherein a concentration of one or more chemicals disposed within each packed layer is predetermined.

18. The chemical strainer of claim 6, wherein a volume of one or more chemicals disposed within each packed layer is predetermined.

19. The chemical strainer of claim 6, further comprising:
a dissolvable isolation layer disposed between packed layers of one or more chemicals.

20. The chemical strainer of claim 6, wherein the plurality of packed layers are configured to provide a predetermined sequence of one or more chemicals.

21. A method of chemical straining comprising:
receiving production fluids in a plurality of base member dispensing apertures of a chemical strainer;
dispensing one or more chemicals disposed within the chemical strainer;
mixing the production fluids and the dispensed chemicals; and
producing treated production fluids.

22. The method of claim 21, wherein the one or more chemicals are disposed within a plurality of packed layers, each packed layer comprising one or more treatment chemicals.

23. The method of claim 21, wherein the plurality of packed layers are disposed within a base member cavity.

24. The method of claim 21, wherein the plurality of packed layers are disposed within a standpipe cavity.

25. The method of claim 21, wherein the plurality of packed layers are disposed in a chemical cartridge.

26. The method of claim 22, wherein the plurality of packed layers are isolated from one another by one or more dissolvable isolation layers.

27. The method of claim 22, wherein a type of one or more treatment chemicals disposed within each packed layer is predetermined.

28. The method of claim 22, wherein a concentration of one or more treatment chemicals disposed within each packed layer is predetermined.

29. The method of claim 22, wherein a volume of one or more treatment chemicals disposed within each packed layer is predetermined.
